(19) United States
(12) Patent Application Publication
(10) Pub. No.: US 2005/0060294 A1
(43) Pub. Date: Mar. 17, 2005

(54) Advertising based on a search string and user attribute combination

(76) Inventor: Jim E. Rainey, Mountain View, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/661,220

(22) Filed: Sep. 12, 2003

(51) Int. Cl. G06F 17/30

(52) U.S. Cl. 707/3

(57) ABSTRACT

The invention provides a method. The method comprises receiving a user-input search string from a node; determining an attribute of the user; determining if there is an advertisement associated with the search string and attribute combination; performing a search based on the search string using a search engine; and causing the advertisement to be displayed together with a result of the search on a display associated with the node.

### FIELD OF THE INVENTION

This invention relates to on-line advertising using a Wide Area Network (WAN), such as the Internet. In particular, the invention relates to a type of on-line advertising known as paid placement advertising and to a type of on-line advertising known as paid inclusion.

### BACKGROUND

Both paid placement and paid inclusion advertising refer to a type of on-line advertising in which advertisers pay to have their advertisements associated with a particular search string so that when the search string is input into a search engine, the advertisements are displayed together with a result of the search. With paid placement advertisers bid to have their associated advertisements “placed” at a particular spot usually within the top ten or so results of the search.

Paid inclusion advertising differs from paid placement advertising in that advertisers pay for their associated advertisements to be included in the results of the search without bidding for a particular spot. Since the advertisements, with paid placement and paid inclusion advertising, are linked to a search string, the association of the advertisement with the results of the search is based on the search string and, in some cases, metrics relating to the advertisement itself, e.g., the number of times users have clicked through or selected the advertisement.

### BRIEF DESCRIPTION OF THE DRAWINGS

FIG. 1 shows a flowchart of operations performed by a system, in accordance with one embodiment of the invention;

FIGS. 2 through 5 show examples of the bidding interface that may be used to place a bid, in accordance with embodiments of the invention;

FIG. 6 shows a flowchart of operations performed by a system, in accordance with another embodiment of the invention; and

FIG. 7 shows a block diagram of a system that may be used to perform embodiments of the present invention.

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

In one embodiment, the invention provides a mechanism for advertisers to bid for the placement of advertisements on a search engine results page based on a combination of search string and location. Bids for particular search string and location combinations are received from multiple advertisers, and a winning bid is determined. The winning bid is associated with a particular advertisement for the winning bidder, which advertisement is inserted into a results page whenever the search string is input into a search engine using a computer whose location data matches the location in the winning search string and location combination. Thus, in this embodiment, placement of advertisement within the results of search engines is based on a combination of search string and location. This embodiment affords advertisers the ability to narrow down the broad scope of particular search strings to narrow well-defined target audiences from particular locations. One advantage of narrowing the target audience of a paid placement advertisement based on location, as described, is that the cost of the advertisement may be reduced since the advertisements now reach a smaller target audience. Furthermore, since the paid placement advertisement are now displayed based on a combination of search string and location, small business enterprises that operate exclusively within certain geographic areas will benefit from the lower paid placement advertising costs, as well as having a location-specific target audience.

In another embodiment, the invention provides a system that determines a location at which a search string to a search engine was input and displays a paid placement advertisement associated with the search string and location combination.

Other advantages of the invention will become apparent from the following description.

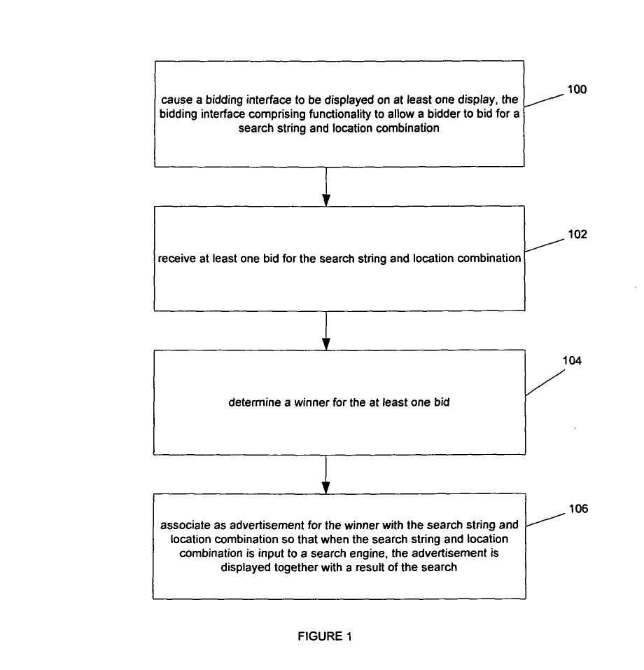

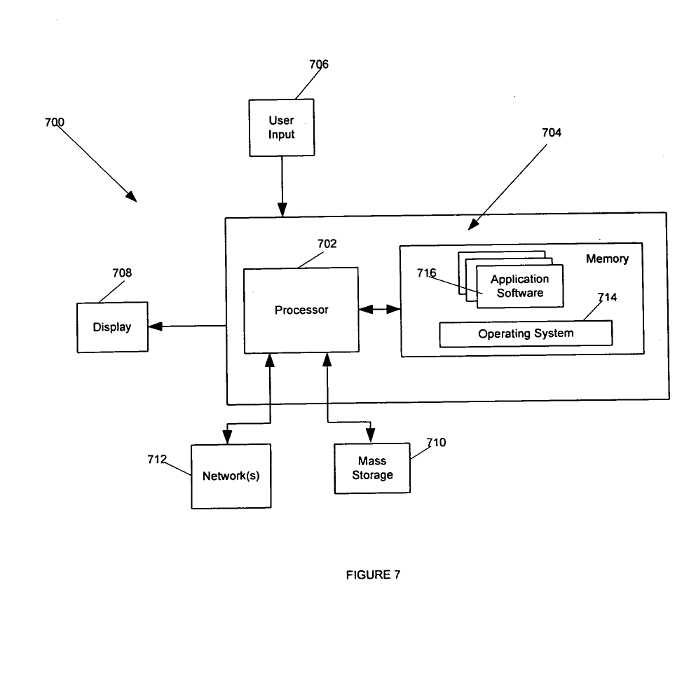

Referring now to FIG. 1 of the drawings, there is shown a flowchart of operations performed by a system, such as the system 700 shown in FIG. 7 of the drawings, in accordance with one embodiment of the invention. Referring to FIG. 1, at block 100, system causes a bidding interface to be displayed on a display of the system. The bidding interface comprises functionality to allow a bidder to bid for a search string and location combination. For example, the bidder may be a business enterprise that sells digital cameras and would like to have an advertisement inserted into a result of a search based on the search string “digital camera.” In other embodiments, the search string may take the form of a search category, e.g., music, automobiles, movies, etc. However, the business enterprise is a small to medium business enterprise only having a local presence, for example, in Sunnyvale, Calif., and may not be interested in having the advertisement inserted in a result of a search page in the case where the person inputting the search string resides, for example, in a different state. The bidding interface allows the business enterprise/advertiser to bid for the search string, “digital camera” and some indicator of location that will guarantee that placement of the advertisement within a result of a search will only take place in cases where computers used to perform searches are within the location forming part of the search string and location combination.

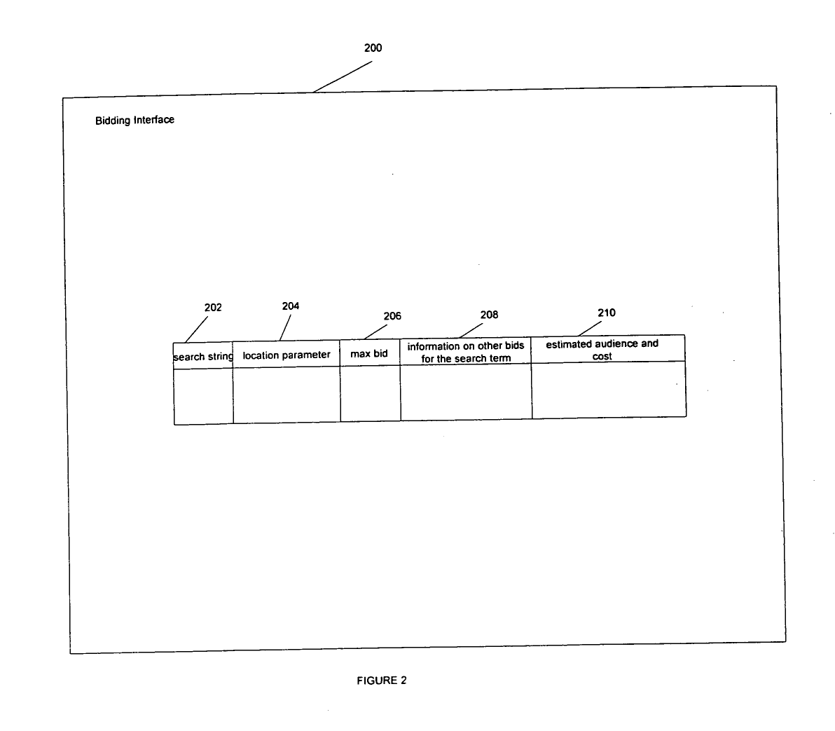

FIG. 2 of the drawings shows a block diagram of a bidding interface 200, in accordance with one embodiment of the invention. Referring to FIG. 2, it will be seen that the bidding interface 200 includes a search string column 202 wherein a user may input a search string, for example, “digital camera.” The interface 200 also includes a location parameter column 204, wherein the user may input some parameter or indication of location. For example, in one embodiment, the location parameter may be a zip code, a state, or even a range of network addresses. In column 204 of interface 200, the user enters the maximum bid that he or she wishes to place for the search string and location combination. The interface 200 may optionally include a column 206, wherein information on other bids for the search term and location combination are indicated. The column 206 provides guidance on what amount to bid. The interface 200 also includes a column 208 which provides an indication as to the estimated audience that paid placement advertisements would reach, as well as the cost thereof.

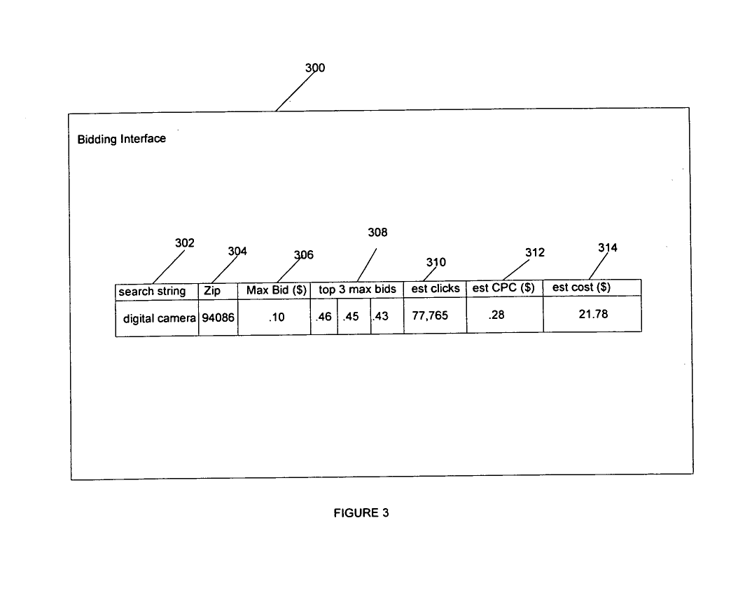

Referring now to FIG. 3 of the drawings, reference number 300 generally indicates a bidding interface 300, in accordance with one embodiment of the invention. As with the interface 200, the interface 300 includes a search string column 302 and a location parameter column in the form of a column 304 wherein a user (e.g., an advertiser or an agent on behalf on the advertiser, may enter a postal code, e.g., a zip code of a location of interest. Column 306 indicates the maximum bid that the advertiser wishes to bid for the search string and location combination: “digital camera”, “306.” At column 308, the interface 300 provides information on the current three maximum bids, by other bidders. Column 310 provides an estimated number of expected clicks for the search string “digital camera”. At column 312 the estimated cost per click (CPC), is provided. Column 314 provides the estimated cost based on the total amount of estimated clicks.

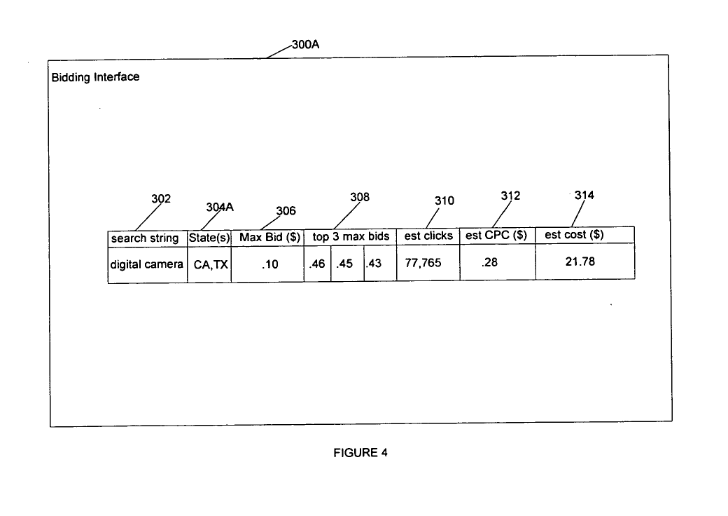

FIG. 4 of the drawings shows an embodiment 300A of the bidding interface which is similar to the bidding interface 300 of FIG. 3, except that the location parameter is in the form of column 304A, wherein a bidder may input the states for which the bidder wishes to pay for advertisement placement.

It is important to bear in mind that the invention extends to any type of location delimiter that may be combined with a search string to narrow the scope of the audience that views a paid placement advertisement. Thus, besides geographic location, a location indicator in the form of a network address, a Direct Marketing Association (DMA) code, a state, a city, etc. In some cases, the location indicator may include a combination of any of the above enumerated location indicators. In other cases, the location indicator may comprise a single value or a range of values, e.g., a range of network addresses.

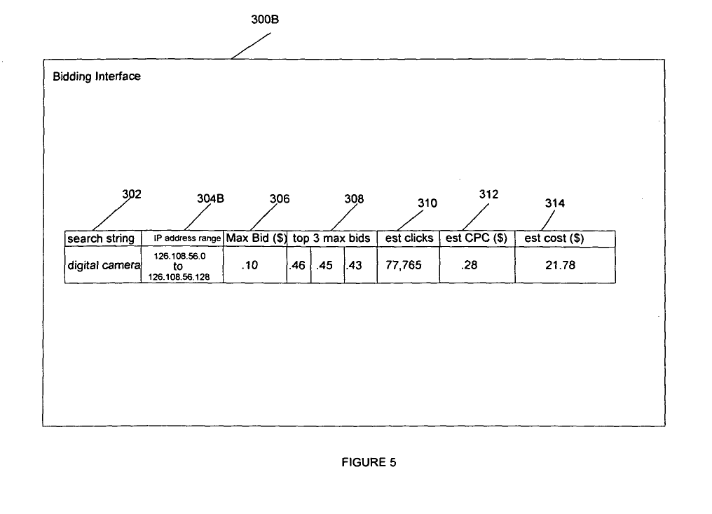

FIG. 5 shows an example of a bidding interface 300B which is similar to the interfaces 300 and 300A of FIGS. 3 and 4 of the drawings, except that the location indicator now takes the form of the network address range 304B. In this particular case, the network address range is in the form of an Internet Protocol (IP) address range.

The interfaces shown in FIGS. 2 to 5 of the drawings are displayed on a user's computer display using browser software. Once information required by the bidding interface is input, the user clicks a button which causes the browser to send the bid information to the system.

Referring again to FIG. 1 of the drawings, at block 102, the system receives the bid information from various bidders. At block 104, the system determines a winner for the particular keyword and location combination. Thereafter, at 106, the system associates an advertisement for the winner with the search string and location combination, so that when the search string and location combination is input to a search engine, the advertisement is displayed together with the results of the search. In one embodiment, the system may allow each bidder to compose the advertisement which is the subject of the paid placement.

The association of the advertisement with the winning search string and location combination may be performed, in one embodiment, by creating a link or a mapping between the advertisement and the winning search string and location combination within a database. Thus, whenever the winning search string and location combination is input into a search engine, the search engine accesses the database and retrieves the advertisement associated with the winning search string and location combination. Therefore, the system causes a result of the search to be displayed together with the associated advertisement.

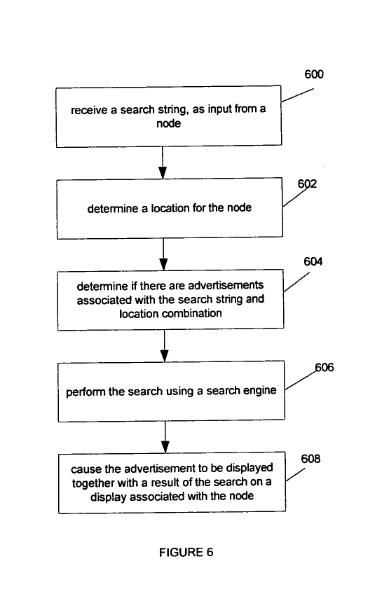

Referring now to FIG. 6 of the drawings, there is shown a flowchart of operations formed in accordance with another embodiment of the invention, by a system such as the system 700 shown in FIG. 7 of the drawings. Referring to FIG. 6, at block 600, the system receives a search string as input, from a node. Typically, the node is a node within a Wide Area Network (WAN), such as the Internet and may take the form of a user's computer. At block 602, the system determines a location for the node. Various techniques may be used to determine the location of the node. In one embodiment, the user may be prompted to input the location. For example, in one embodiment, the user may be prompted to enter a zip code of his/her present location, or a zip code to be associated the search string. In another embodiment, the system may determine the location for the node based on a network address of the node. For example, the system may determine that the node has a particular network address and may then map the network address to a particular physical location.

At block 604, the system determines if there are advertisements associated with the search string and location combination. At block 606, the system performs the search using a search engine. Thereafter, at block 608, the system causes the advertisement to display together with a result of the search on a display associated with the node. In one embodiment, the system composes the result of the search and the paid placement advertisements associated with the search string and location combination in a single feed which is then sent to the node to be displayed by a browser of the node.

Referring to FIG. 7 of the drawings, reference numeral 700 generally indicates a system that may be used to practice embodiments of the present invention. The system 700 typically includes at least one processor 702 coupled to a memory 704. The processor 702 may represent one or more processors (e.g. microprocessors), and the memory 704 may represent random access memory (RAM) devices comprising a main storage of the system 700, as well as any supplemental levels of memory e.g., cache memories, non-volatile or back-up memories (e.g. programmable or flash memories), read-only memories, etc. In addition, the memory 704 may be considered to include memory storage physically located elsewhere in the system 700, e.g. any cache memory in the processor 702, as well as any storage capacity used as a virtual memory, e.g., as stored on a mass storage device 710.

The system 700 also typically receives a number of inputs and outputs for communicating information externally. For interface with a user or operator, the system 700 may include one or more user input devices 706 (e.g., a keyboard, a mouse, etc.) and a display 708 (e.g., a Cathode Ray Tube (CRT) monitor, a Liquid Crystal Display (LCD) panel).

For additional storage, the system 700 may also include one or more mass storage devices 710, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the system 700 may include an interface with one or more networks 712 (e.g., a Local Area Network (LAN), a WAN, a wireless network, and/or the Internet among others) to permit the communication of information with other computers coupled to the networks. It should be appreciated that the system 700 typically includes suitable analog and/or digital interfaces between the processor 702 and each of the components 704, 706, 708 and 712 as is well known in the art.

The system 700 operates under the control of an operating system 714, and executes various computer software applications 716, components, programs, objects, modules, etc. (e.g. a program or module which performs operations as shown in FIGS. 1 and 6 of the drawings). Moreover, various applications, components, programs, objects, etc. may also execute on one or more processors in another computer coupled to the system 700 via a network 712, e.g. in a distributed computing environment, whereby the processing required to implement the functions of a computer program may be allocated to multiple computers over a network.

In general, the routines executed to implement the embodiments of the invention, may be implemented as part of an operating system or a specific application, component, program, object, module or sequence of instructions referred to as “computer programs”. The computer programs typically comprise one or more instructions set at various times in various memory and storage devices in a computer, and that, when read and executed by one or more processors in a computer, cause the computer to perform these steps necessary to execute steps or elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of signal bearing media used to actually effect the distribution. Examples of signal bearing media include but are not limited to recordable type media such as volatile and non-volatile memory devices, floppy and other removable disks, hard disk drives, optical disks (e.g. CD ROMS, DVDs, etc.), among others, and transmission type media such as digital and analog communication links.

One advantage of the techniques described above is that the relevancy of the advertisements, associated with the results of a search, to a person requesting the search is increased. In the case of the embodiments described above associating the advertisements with the search results is based on the user-input search string as well as the location of the user, thus increasing the relevancy of the associated advertisements.

The present invention is not limited to techniques that associate the advertisement with the search results based on a combination of user-input search string and a location of the user, but extends more broadly to techniques that associate the advertisement within the search results based on a combination of user-input search string and an attribute of the user. In some embodiments, the attribute of the user may include the age, gender, income, etc. of the user.

The age of the user may be expressed in a variety of ways for example, as the numerical age of the user in years, as the user's birth date, as the user's birth year, as an age range (e.g., 18-22), or as an English description of an age range (e.g., teen, young adult, senior). Advertisers could bid for single values (e.g., 21), for multiple values (e.g., 21, 25, 28), or ranges of values (e.g., 21-29), in conjunction with keywords. Examples of combinations of user-input search strings and user attributes in which the user attribute is an age include the following combinations:
“Digital Camera”+22;
“Watches”+young adult, adult;
“Sporting Goods”+Jun. 12, 1965; and
“Casino” or “Gambling”+1960-1982.

In the case of the user attribute being the age of the user, the age of the user may be gathered and stored in a variety of ways including, for example, asking the user to enter his/her age or birth date and then storing the age in a “cookie”, or storing the information on a server and then associating the age with the user using an authentication service.

In the case of the user attribute being the gender of the user, the gender could be expressed in a variety of formats including: a gender—indicating word (e.g., male, female, other, did not specify), a value which corresponds to a gender indication (e.g., M, F, etc.) or a separate element that can be correlated to a gender value (e.g., the first name of a person). Advertisers would then bid for single values (e.g., male) or for multiple values (e.g., female, other) in conjunction with keywords. Examples of combinations of user-input search strings and user attributes, in which the user attribute is the gender of the user include:
“Digital Camera”+male;
“Watches”+female or did not specify; and
“Casino” or “Gambling”+male.
   In the case of the user attribute being the gender of the user, the gender can be gathered and stored in a variety of ways including, for example, asking a user to enter the gender (or their name) and then storing the entry in a “cookie”, or storing the gender on a server and then associating the gender with the user using an authentication service.

Although the present invention has been described with reference to specific exemplary embodiments, it will be evident that the various modification and changes can be made to these embodiments without departing from the broader spirit of the invention as set forth in the claims. Accordingly, the specification and drawings are to be regarded in an illustrative sense rather than in a restrictive sense.

1. A method, comprising:
receiving a user-input search string from a node;
determining an attribute of the user;
determining if there is an advertisement associated with the search string and attribute combination;
performing a search based on the search string using a search engine; and
causing the advertisement to be displayed together with a result of the search on a display associated with the node.

2. The method of claim 1, wherein the attribute of the user is selected from the group consisting of the age, gender, income, and location of the user.

3. The method of claim 2, wherein the location comprises a geographic location of the node.

4. The method of claim 2, wherein the location comprises a network address of the node.

5. The method of claim 3, wherein determining the location comprises prompting the user for input of a location indicator for the node.

6. The method of claim 5, wherein the location indicator is selected from the group consisting of a postal code, a network address, a state, and a city.

7. The method of claim 4, wherein determining the location comprises mapping the network address of the node to a physical location.

8. The method of claim 1, wherein causing the advertisement to be displayed comprises composing the search result and the advertisement into a single feed; and sending the feed to the node for display by a browser.

9. A method, comprising:
causing a bidding interface to be displayed on at least one display, the bidding interface comprising functionality to allow a bidder to bid for a search string and attribute combination, wherein the attribute is an attribute of a user who input the search string;
receiving at least one bid for the search string and attribute combination;
determining a winner of the at least one bid; and
associating an advertisement for the winner with the search string and attribute combination so that when the search string and attribute combination is input to a search engine, the advertisement is displayed together with a result of the search.

10. The method of claim 9, wherein determining the winning bid is based on a monetary amount of the bid.

11. The method of claim 9, wherein the bidding interface displays at least some of the bids that have been received for the search string and attribute combination.

12. The method of claim 9, wherein the attribute comprises a location in the form of a geographic location of the user.

13. The method of claim 9, wherein the attribute comprises a location in the form of a network address of a computer of the user.

14. A computer readable medium, having stored thereon a sequence of instructions which when executed by a processor, cause the processor to perform a method comprising:
receiving a user-input search string from a node;
determining an attribute of the user;
determining if there is an advertisement associated with the search string and attribute combination;
performing a search based on the search string using a search engine; and
causing the advertisement to be displayed together with a result of the search on a display associated with the node.

15. The computer readable medium of claim 14, wherein the attribute of the user is selected from the group consisting of the age, gender, income, and location of the user.

16. The computer readable medium of claim 15, wherein the location comprises a geographic location of the node.

17. The computer readable medium of claim 15, wherein the location comprises a network address of the node.

18. The computer readable medium of claim 16, wherein determining the location comprises prompting the user for input of a location indicator for the node.

19. The computer readable medium of claim 18, wherein the location indicator is selected from the group consisting of a postal code, a network address, a state, and a city.

20. The computer readable medium of claim 17, wherein determining the location comprises mapping the network address of the node to a physical location.

21. The computer readable medium of claim 14, wherein causing the advertisement to be displayed comprises composing the search result in the advertisement into a single feed; and sending the feed to the node for display by a browser.

22. A computer readable medium, having stored thereon a sequence of instructions which when executed by a processor, cause the processor to perform a method comprising:
causing a bidding interface to be displayed on at least one display, the bidding interface comprising functionality to allow a bidder to bid for a search string and attribute combination, wherein the attribute is an attribute of a user who input the search string;
receiving at least one bid for the search string and attribute combination;
determining a winner of the at least one bid; and
associating an advertisement for the winner with the search string and attribute combination so that when the search string and attribute combination is input to a search engine, the advertisement is displayed together with a result of the search.

23. The computer readable medium of claim 22, wherein determining the winning bid is based on the monetary amount of the bid.

24. The computer readable medium of claim 22, wherein the bidding interface displays at least some of the bids that have been received for the search string and attribute combination.

25. The computer readable medium of claim 22, wherein the attribute comprises a location in the form of a geographic location of the user.

26. The computer readable medium of claim 22, wherein the attribute comprises a location in the form of a network address of a computer of the user.

27. A system, comprising:
a processor;
a memory coupled to the processor, the memory storing instructions which when executed by the processor, cause the system to perform a method comprising:
receiving a user-input search string from a node;
determining an attribute of the user;
determining if there is an advertisement associated with the search string and attribute combination;
performing a search based on the search string using a search engine; and
causing the advertisement to be displayed together with a result of the search on a display associated with the node.

28. The system of claim 27, wherein the attribute of the user is selected from the group consisting of age, gender, income, and location of the user.

29. The system of claim 28, wherein the location comprises a geographic location of the node.

30. The system of claim 28, wherein the location comprises a network address of the node.

31. The system of claim 29, wherein determining the location comprises prompting the user for input of a location indicator for the node.

32. The system of claim 31, wherein the location indicator is selected from the group consisting of a postal code, a network address, a state, and a city.

33. The system of claim 30, wherein determining the location comprises mapping the network address of the node to a physical location.

34. The system of claim 27, wherein causing the advertisement to the display comprises composing the search results and the advertisement into a single feed; and sending the feed to the node for display by a browser.

35. A system, comprising:
a processor;
a memory coupled to the processor, the memory storing instructions which when executed by the processor, cause the system to perform a method comprising:
causing a bidding interface to be displayed on at least one display, the bidding interface comprising functionality to allow a bidder to bid for a search string and attribute combination, wherein the attribute is an attribute of a user who input the search string;
receiving at least one bid for the search string and attribute combination;
determining a winner of the at least one bid; and
associating an advertisement for the winner with the search string and attribute combination so that when the search string and attribute combination is input to a search engine, the advertisement is displayed together with a result of the search.

36. The system of claim 35, wherein determining a winning bid is based on a monetary amount of the bid.

37. The system of claim 35, wherein the bidding interface displays at least some of the bids that have been received for the search string and attribute combination.

38. The system of claim 35, wherein the attribute comprises a location in the form of a geographic location of the user.

39. The system of claim 35, wherein the attribute comprises a location in the form of a network address of a computer of the user.
